(19) United States
(12) Patent Application Publication
(10) Pub. No.: US 2020/0035140 A1
(43) Pub. Date: Jan. 30, 2020

(54) DRIVING METHOD AND DRIVING DEVICE OF DISPLAY PANEL AND DISPLAY DEVICE

(71) Applicants: HKC Corporation Limited, Baoan Dist, Shenzhen (CN); Chongqing HKC Optoelectronics Technology Co., Ltd., Chongqing (CN)

(72) Inventor: YU-JEN CHEN, Chongqing (CN)

(21) Appl. No.: 15/740,359

(22) PCT Filed: Jul. 4, 2017
(86) PCT No.: PCT/CN2017/091653

§ 371 Date: Dec. 28, 2017

(30) Foreign Application Priority Data
Jun. 6, 2017 (CN) 201710424977.X

(51) Int. Cl. G09G 3/20

(52) U.S. Cl. CPC G09G 3/2003; G09G 2320/041; G09G 2310/08; G09G 2310/0275; G09G 2300/0408; G09G 2300/0443

(57) ABSTRACT

A driving method and a driving device of a display panel and a display device are provided. By grouping a pixel array of the display panel, the sub-pixels of the first row or the last row of each pixel group are blue sub-pixels. In the process of driving the pixel array, the polarities of the driving voltage signals outputted from a source driving IC are controlled to be periodically inverted so that the polarities of the sub-pixels in each individual pixel group are the same and the polarities of any adjacent two of the pixel groups are opposite. The operating frequency of the source driving IC can effectively be reduced, thereby reducing the heat generated by the source driving IC and improving its service life.

### CROSS-REFERENCE TO RELATED APPLICATION

This application claims the benefit of China Patent Application No. 201710424977.X, filed on Jun. 6, 2017, in the State Intellectual Property Office of the People's Republic of China, the disclosure of which is incorporated herein in its entirety by reference.

### FIELD OF THE INVENTION

The present application relates to the display technology, and more particularly to a driving method and a driving device of a display panel and a display device.

### BACKGROUND OF THE INVENTION

With the continuous development of science and technology, a variety of display devices are developed on the market. A display panel based on the three-gate transistor (Tri-Gate, three-dimensional transistor) technology is able to achieve a variety of gray level and multi-color changes, so that the colors of the display panel are richer and the display panel can be widely used.

However, in the tri-gate transistor technology, each sub-pixel in the display panel needs to be connected with a scan line for charging, so the charging time of each sub-pixel is forced to be shortened. As a result, the operating frequency of a source driving IC configured for driving the pixel increases. The source driving IC generates great heat, which seriously reduces the service life of the source driving IC.

### SUMMARY OF THE INVENTION

The primary object of the present application is to provide a driving method and a driving device of a display panel and a display device in order to solve the problems of the tri-gate transistor technology, in which each sub-pixel in the display panel needs to be connected with a scan line for charging, so the charging time of each sub-pixel is forced to be shortened. As a result, the operating frequency of the source driving IC configured for driving the pixel increases. The source driving IC generates great heat, which seriously reduces the service life of the source driving IC.

According to one aspect of the embodiment of the present application, a driving method of a display panel is provided. The driving method comprises the following steps: grouping a pixel array of the display panel, each pixel group including M×N sub-pixels, the sub-pixels of the first row or M-th row of each pixel group being blue sub-pixels; wherein M, N≥1 and are positive integers; in the process of driving the pixel array, controlling the polarities of driving voltage signals outputted from a source driving IC connected with the pixel array to be periodically inverted so that the polarities of the sub-pixels in each individual pixel group are the same and the polarities of any adjacent two of the pixel groups are opposite.

According to another aspect of the embodiment of the present application, a driving device of a display panel is provided. The display panel comprises a pixel array and a source driving IC. The pixel array includes a plurality of pixel groups. Each pixel group includes M×N sub-pixels. The sub-pixels of the first row or the M-th row of each pixel group are blue sub-pixels. Wherein, M, N≥1 and are positive integers. The source driving IC is connected with the pixel array and configured for data driving control of the pixel array. The driving device comprises a control module. The control module is connected with the source driving IC and configured for controlling the polarities of driving voltage signals outputted from the source driving IC to be inverted periodically in the process of driving the pixel array so that the polarities of the sub-pixels in each individual pixel group are the same and the polarities of any adjacent two of the pixel groups are opposite.

According to another aspect of the present application, a display device is provided. The display device comprises a display panel and the aforesaid driving device connected with the display panel.

By grouping the pixel array of the display panel, the sub-pixels of the first row or the last row of each pixel group are blue sub-pixels. In the process of driving the pixel array, the polarities of the driving voltage signals outputted from the source driving IC are controlled to be periodically inverted so that the polarities of the sub-pixels in each individual pixel group are the same and the polarities of any adjacent two of the pixel groups are opposite.

### BRIEF DESCRIPTION OF THE DRAWINGS

These and/or other aspects will become apparent and more readily appreciated from the following description of the embodiments, taken in conjunction with the accompanying drawings, in which:

FIG. 1 is a schematic view of an exemplary display panel based on the three-gate transistor technology;

FIG. 2 is a schematic view showing the driving polarities when the pixel array in FIG. 1 is driven by the exemplary dot inversion method;

FIG. 3 is a schematic view showing the operating frequency of a source driving IC when the pixel array is driven by the driving polarities shown in FIG. 2;

FIG. 4 is a flow chart of a driving method of a display panel in accordance with an embodiment of the present application;

FIG. 5 is a schematic view showing the driving polarities when the pixel array in FIG. 1 is driven by the driving method of FIG. 4;

FIG. 6 is a schematic view showing the driving voltages of the source driving IC when the pixel array is driven by the driving polarities shown in FIG. 5 in accordance with an embodiment of the present application;

FIG. 7 is a schematic view showing the driving polarities when the pixel array in FIG. 1 is driven by the driving method of FIG. 4;

FIG. 8 is a schematic view showing a driving device of a display panel in accordance with an embodiment of the present application; and

FIG. 9 is a schematic view showing a display device in accordance with an embodiment of the present application.

### DESCRIPTION OF THE PREFERRED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein.

It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. It will be understood that, although the terms “first,” “second,” and “third” etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

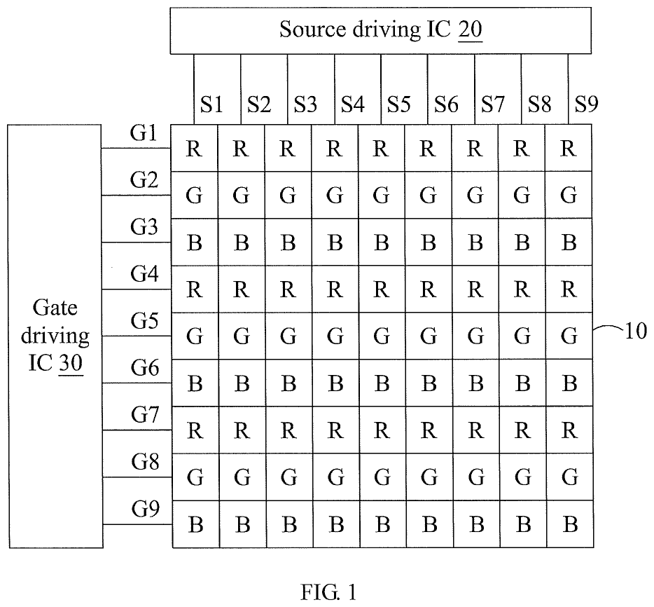

As shown in FIG. 1, a display panel based on the tri-gate transistor technique includes a pixel array 10, a source driving IC 20, and a gate driving IC 30. The pixel array 10 comprises a plurality of sub-pixels. The colors of the sub-pixels of each row are the same. The colors of any adjacent two of the sub-pixels of the same column are different.

In specific applications, the number of rows and columns of the sub-pixels of the pixel array 10 is determined by the size of the tri-gate transistor and the size of the display panel.

As shown in FIG. 1, the pixel array 10 includes nine columns of sub-pixels and nine rows of sub-pixels, i.e., the total number of sub-pixels of the pixel array 10 is 9×9; correspondingly, the source driving IC 20 leads to nine scan lines connected with nine columns of sub-pixels, denoted as S1, S2, . . . , S8 and S9, respectively. Nine data lines of the source driving IC 20 sequentially output data signals for data driving control for each column of sub-pixels. The gate driving IC 30 leads to nine scan lines connected with nine rows of sub-pixels, denoted G1, G2, . . . , G8 and G9, respectively. The nine scan lines of the gate driving IC 30 sequentially output scan signals to the sub-pixels of each row for charging.

In a specific application, the colors of the sub-pixels of the same column in the pixel array 10 may be set according to actual needs.

In an embodiment, the sub-pixels of the same column of the pixel array 10 is periodically arranged in the order of the first color sub-pixel, the second color sub-pixel, and the third color sub-pixel.

As shown in FIG. 1, the first color is red (i.e., Red, represented by R in FIG. 1), the second color is green (i.e., Green, represented by G in FIG. 1), and the third color is blue (i.e., Blue, represented by B in FIG. 1).

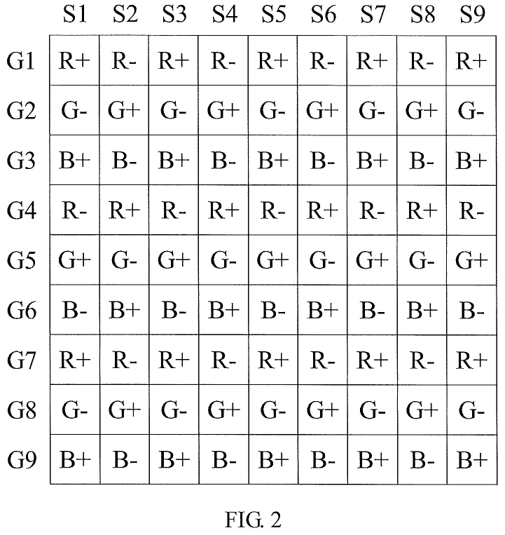

As shown in FIG. 2, the polarities of the adjacent sub-pixels are different when the pixel array in FIG. 1 is driven by the ordinary dot inversion method. The driving polarity of the red sub-pixel located in the S1 column and the G1 row in FIG. 1 is positive (the symbol is represented by + in FIG. 2); the driving polarity of the green sub-pixel located in the S1 column and the G2 row is negative (the symbol is represented by − in FIG. 2); the driving polarity of the blue sub-pixel located in the S1 column and the G3 row is positive; and the driving polarity of the other pixels is analogized according to the aforementioned rule which defines that “the polarities of the adjacent sub-pixels are different”. The details will not be listed hereinafter. In the actual practice, the driving polarity the red sub-pixels located in the S1 column and the G1 row may also be negative, and correspondingly, the aforementioned rule may be applied to other sub-pixels and the details will not be listed hereinafter.

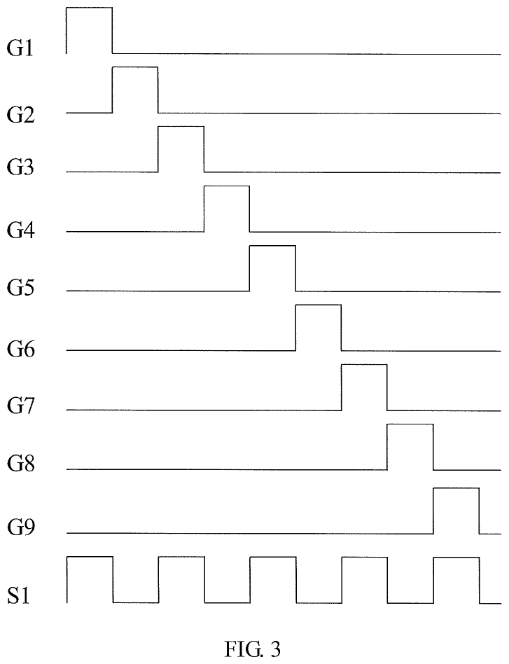

As shown in FIG. 3, when the pixel array is driven in accordance with the driving polarities shown in FIG. 2, the nine scan lines G1-G9 of the gate driving IC 30 sequentially output high level signals to charge the sub-pixels located in the S1 column, respectively. Each time the data line S1 of the source driving IC 20 drives a driving voltage signal outputted by each sub-pixel located in the S1 column to be inverted, and the operating frequency becomes the inversion frequency of the outputted driving voltage signal. The inversion frequency of the driving voltage signals outputted from the other data lines S2-S8 of the source driving IC 20 is the same as that of the data line S1. FIG. 3 only illustrates the driving voltage signals when the sub-pixels in the S1 column are driven, as an example. The convex waveform in FIG. 3 represents a high level signal, and the concave waveform represents a low level signal.

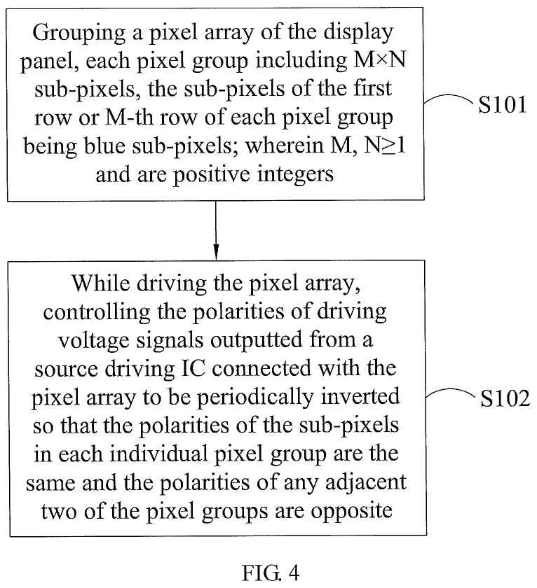

As shown in FIG. 4, an embodiment of the present application provides a driving method of a display panel for driving the pixel array shown in FIG. 1. The driving method comprises the following steps:

Step S101: grouping the pixel array of the display panel, each pixel group including M×N sub-pixels, the sub-pixels of the first row or M-th row of each pixel group being blue sub-pixels; wherein M, N≥1 and are positive integers;

Step S102: in the process of driving the pixel array, the polarities of the driving voltage signals outputted from the source driving IC connected with the pixel array are controlled to be periodically inverted so that the polarities of the sub-pixels in each individual pixel group are the same and the polarities of any adjacent two of the pixel groups are opposite.

In an embodiment, the sub-pixels of the first row of each pixel group are first color sub-pixels, the sub-pixels of the second row are second color sub-pixels, and the sub-pixels of the third row are third color sub-pixels. Wherein, the first color sub-pixels are blue sub-pixels.

In an embodiment, the sub-pixels of the first row of each pixel group are first color sub-pixels, the sub-pixels of the second row are second color sub-pixels, and the sub-pixels of the third row are third color sub-pixels. Wherein, the third color sub-pixels are blue sub-pixels.

In a specific application, the first color, the second color, or the third color may be any one of red, green and blue. The three colors may be different or partially different, as long as the sub-pixels of the first row or the last row are blue.

In a specific application, the values of M and N can be set according to the actual needs. The value of M has a negative linear correlation with the operating frequency of the source driving IC, that is, the larger the M is, the lower the operating frequency of the source driving IC will be and the less the heat would be generated. Similarly, the value of N has a negative linear correlation with the operating frequency of the gate driving IC, that is, the larger the N is, the lower the operating frequency of the gate driving IC will be and the less the heat would be generated.

In an embodiment, M=3 and N=1.

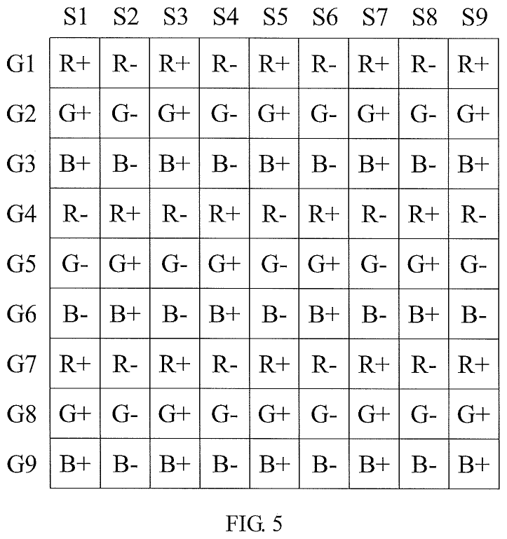

FIG. 5 illustrates the driving polarities of the pixel array in FIG. 1 driven by the aforementioned driving method when M=3 and N=1. In FIG. 5, the driving polarities of the three sub-pixels in each individual pixel group of the same column are the same, and the polarities of any adjacent two of the pixel groups are opposite. The driving polarities of the sub-pixels shown in FIG. 5 are exemplary. In practical applications, the driving polarity of each sub-pixel in FIG. 5 may be opposite to the polarity shown in FIG. 5, which is also within the protection scope of the above-mentioned driving method of the present application.

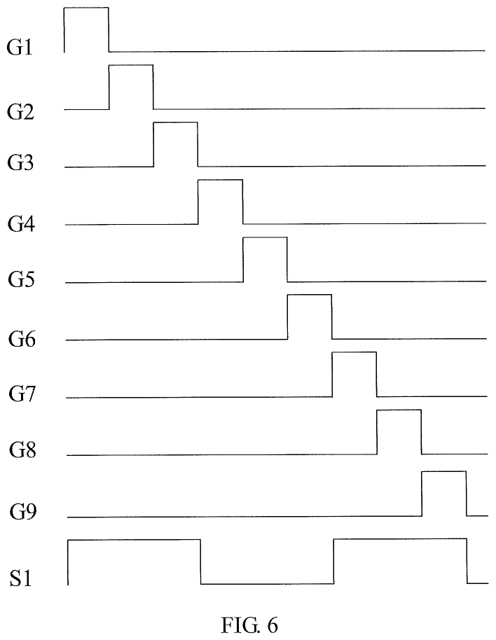

As shown in FIG. 6, when the pixel array is driven in accordance with the driving polarities shown in FIG. 5, the nine scan lines G1-G9 of the gate driving IC 30 sequentially output high level signals to charge the sub-pixels located in the S1 column, respectively. Each time the data line S1 of the source driving IC 20 drives the polarities of the driving voltage signals outputted by the three sub-pixels of each pixel group in the S1 column to be inverted once, the operating frequency becomes the inversion frequency of the polarities of the outputted driving voltage signals. The inversion frequency of the polarities of the driving voltage signals outputted from the other data lines S2-S8 of the source driving IC 20 is the same as that of the data line S1. FIG. 6 only illustrates the driving voltage signals when the sub-pixels in the S1 column are driven, as an example. The convex waveform in FIG. 5 represents a high level signal, and the concave waveform represents a low level signal.

As shown in FIG. 3 and FIG. 6, when the pixel array is driven in accordance with the driving polarities shown in FIG. 5, the operating frequency of the source driving IC 20 can be reduced to one third when the pixel array is driven in accordance with the driving polarities shown in FIG. 2. Therefore, the operating frequency of the source driving IC 20 can be effectively reduced when the pixel array is driven in accordance with the driving polarities shown in FIG. 5, thereby reducing the heat generated by the source driving IC and improving the service life.

In FIG. 5, the position for each time the polarity of the driving voltage signal to be inverted is located at the position of the blue sub-pixel. Since the human eye is insensitive to blue, the polarity of the driving voltage signal can be inverted at the position of the blue sub-pixel to reduce the influence on the display effect of the display panel.

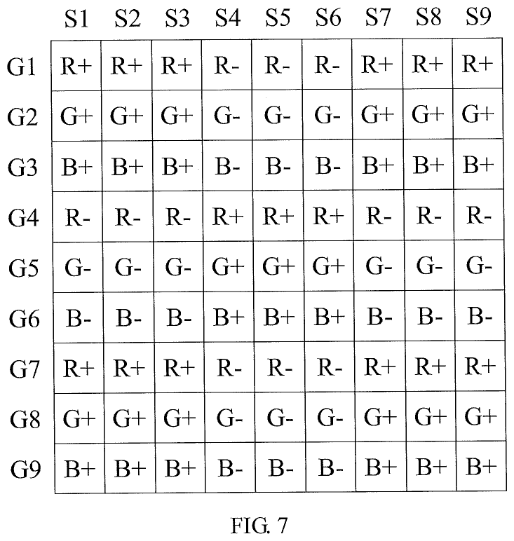

FIG. 7 illustrates the driving polarities of the pixel array in FIG. 1 driven by the aforementioned driving method when M=3 and N=3. In FIG. 7, the driving polarities of the nine sub-pixels in each individual pixel group are the same, and the polarities of any adjacent two of the pixel groups are opposite. The driving polarities of the sub-pixels shown in FIG. 7 are exemplary. In practical applications, the driving polarity of each sub-pixel in FIG. 7 may be opposite to the polarity shown in FIG. 7, which is also within the protection scope of the above-mentioned driving method of the present application.

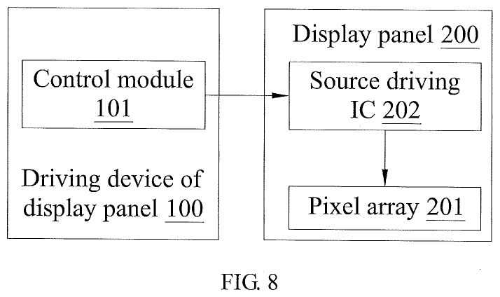

As shown in FIG. 8, the present application discloses a driving device 100 of a display panel. The display panel 200 includes a pixel array 201 and a source driving IC 202. The driving device includes a control module 101.

The pixel array 201 includes a plurality of pixel groups. Each pixel group comprises M×N sub-pixels. The sub-pixels of the first row or the M-th row of each pixel group are blue sub-pixels. Wherein M, N≥1 and are positive integers.

In an embodiment, the pixel array 201 may be the pixel array shown in FIG. 5 or FIG. 7.

The source driving IC 202 is connected with the pixel array 201 for data driving control of the pixel array 202.

In a specific application, the source driving IC 202 may be the source driving IC as described in any of the above embodiments.

The control module 101 is configured for controlling the polarity of the driving voltage signal outputted from the source driving IC 202 to be inverted periodically when the pixel array 201 is driven, so that the polarities of all the sub-pixels in each individual pixel group are the same, and the polarities of any adjacent two of the pixel groups are opposite.

In an embodiment, the control module may be a timing controller, or may be a central processing unit (CPU), or other general-purpose processor, a digital signal processor (DSP), an application specific integrated circuit (ASIC), a field-programmable gate array (FPGAs), or other programmable logic devices, discrete gate or transistor logic devices, discrete hardware components, and the like. The general-purpose processor may be a microprocessor, or the processor may be any conventional processor.

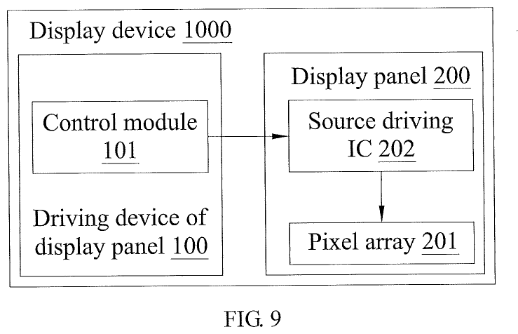

As shown in FIG. 9, the present application also discloses a display device 1000 including the aforementioned driving device 100 and the display panel 200 connected with the driving device 100.

In an embodiment, the display panel may be any type of display panel, such as a liquid crystal display panel based on LCD (Liquid Crystal Display) technology, an organic electroluminescence display panel based on OLED (Organic Electroluminescent Display) technology, a quantum dot light emitting diode display panel based on QLED (Quantum Dot Light Emitting Diodes) technology, or a curved display panel.

It will be understood by those of ordinary skill in the art that all or part of the processes in the method of the embodiments described above may be accomplished by means of a computer program to command the associated hardware. All the processes may be stored in a non-transitory computer-readable storage medium. When the program is executed, the procedures of the above embodiments may be included. The storage medium may be a disk, a CD, a read-only memory (ROM), a random access memory (RAM), or the like.

Although particular embodiments of the present application have been described in detail for purposes of illustration, various modifications and enhancements may be made without departing from the spirit and scope of the present application. Accordingly, the present application is not to be limited except as by the appended claims.

What is claimed is:

1. A driving method of a display panel, comprising the following steps:
grouping a pixel array of the display panel, each pixel group including M×N sub-pixels, the sub-pixels of a first row or M-th row of each pixel group being blue sub-pixels; wherein M, N≥1 and are positive integers;
while driving the pixel array, controlling polarities of driving voltage signals outputted from a source driving IC connected with the pixel array to be periodically inverted so that the polarities of the sub-pixels in each individual pixel group are the same and the polarities of any adjacent two of the pixel groups are opposite.

2. The driving method of the display panel as claimed in claim 1, wherein M=3 and N=1.

3. The driving method of the display panel as claimed in claim 2, wherein the sub-pixels of the first row of each pixel group are first color sub-pixels, the sub-pixels of a second row are second color sub-pixels, and the sub-pixels of a third row are third color sub-pixels;
wherein the first color sub-pixels are blue sub-pixels.

4. The driving method of the display panel as claimed in claim 2, wherein the sub-pixels of the first row of each pixel group are first color sub-pixels, the sub-pixels of the second row are second color sub-pixels, and the sub-pixels of the third row are third color sub-pixels;
wherein the third color sub-pixels are blue sub-pixels.

5. The driving method of the display panel as claimed in claim 1, wherein M=3 and N=3.

6. The driving method of the display panel as claimed in claim 5, wherein the sub-pixels of the first row of each pixel group are first color sub-pixels, the sub-pixels of a second row are second color sub-pixels, and the sub-pixels of a third row are third color sub-pixels;
wherein the first color sub-pixels are blue sub-pixels.

7. The driving method of the display panel as claimed in claim 5, wherein the sub-pixels of the first row of each pixel group are first color sub-pixels, the sub-pixels of a second row are second color sub-pixels, and the sub-pixels of a third row are third color sub-pixels;
wherein the third color sub-pixels are blue sub-pixels.

8. The driving method of the display panel as claimed in claim 1, wherein the display panel is based on tri-gate transistor technology.

9. A driving device of a display panel, the display panel comprising:
a pixel array, including a plurality of pixel groups, each pixel group including M×N sub-pixels, the sub-pixels of a first row or the M-th row of each pixel group being blue sub-pixels, wherein M, N≥1 and are positive integers;
a source driving IC, connected with the pixel array, configured for data driving control of the pixel array;
the driving device comprising:
a control module, connected with the source driving IC, configured for controlling polarities of driving voltage signals outputted from the source driving IC to be inverted periodically while driving the pixel array so that the polarities of the sub-pixels in each individual pixel group are the same and the polarities of any adjacent two of the pixel groups are opposite.

10. The driving device of the display panel as claimed in claim 9, wherein M=3 and N=1.

11. The driving device of the display panel as claimed in claim 10, wherein the sub-pixels of the first row of each pixel group are first color sub-pixels, the sub-pixels of a second row are second color sub-pixels, and the sub-pixels of a third row are third color sub-pixels;
wherein the first color sub-pixels are blue sub-pixels.

12. The driving device of the display panel as claimed in claim 10, wherein the sub-pixels of the first row of each pixel group are first color sub-pixels, the sub-pixels of a second row are second color sub-pixels, and the sub-pixels of a third row are third color sub-pixels;
wherein the third color sub-pixels are blue sub-pixels.

13. The driving device of the display panel as claimed in claim 9, wherein M=3 and N=3.

14. The driving device of the display panel as claimed in claim 13, wherein the sub-pixels of the first row of each pixel group are first color sub-pixels, the sub-pixels of a second row are second color sub-pixels, and the sub-pixels of a third row are third color sub-pixels;
wherein the first color sub-pixels are blue sub-pixels.

15. The driving device of the display panel as claimed in claim 13, wherein the sub-pixels of the first row of each pixel group are first color sub-pixels, the sub-pixels of a second row are second color sub-pixels, and the sub-pixels of a third row are third color sub-pixels;
wherein the third color sub-pixels are blue sub-pixels.

16. The driving device of the display panel as claimed in claim 9, wherein the display panel is based on tri-gate transistor technology.

17. The driving device of the display panel as claimed in claim 9, wherein the control module is a timing controller.

18. A display device, comprising:
a display panel; and
the driving device as claimed in claim 9, connected with the display panel.
